(19) United States
(12) Patent Application Publication
(10) Pub. No.: US 2015/0242824 A1
(43) Pub. Date: Aug. 27, 2015

(54) Systems and Methods for Secure Electronic Ticketing

(71) Applicant: TRAPEZE SOFTWARE ULC, Mississauga (CA)

(72) Inventors: Eamon Stafford, Meath (IE); Larry Breen, Meath (IE)

(21) Appl. No.: 14/429,611

(22) PCT Filed: Sep. 18, 2013
(86) PCT No.: PCT/CA2013/050716

§ 371 Date: Mar. 19, 2015

(30) Foreign Application Priority Data
Sep. 19, 2012 (CA) 2790316

(51) Int. Cl. G06Q 20/04; G06K 9/00; G06Q 20/40

(52) U.S. Cl. CPC G06Q 20/0457; G06Q 20/40; G06K 9/00758

(57) ABSTRACT

Systems and methods for secure electronic tickets are disclosed herein. A image content section on an electronic ticket displays image content, from one or more image content sources, that can be authenticated following one or more of several approaches disclosed herein. Creation and authentication of electronic tickets may be accomplished via aspects and users of the systems described herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Purchases for goods and services are increasingly being made on the Internet. As such purchases increase, there are more opportunities for, and incentives to, commit fraud.

Approaches to fraud prevention, with transactions where the goods or services themselves are directly exchanged for payment are known.

However, when the payment is exchanged for a ticket for such good or service, the transactions become more complex. Further complexity exists when the person or entity responsible for exchanging the electronic ticket for the good or service has nothing to base their decision on except the electronic ticket itself (and not, for example, reference to a list or other source of confirmation). One example where such transactions (where nothing is to be relied upon except the electronic ticket) is for electronic tickets for transit goods and services (buying bus or train tickets).

Several approaches do exist to attempt to ensure that a ticket is valid. However, occurrences of fraud still exist. As such there remains a need for systems and methods for secure electronic ticketing.

### SUMMARY OF THE INVENTION

In a first aspect there is a secure electronic ticket, for the purchase of goods by a purchaser, displayable on a user display of a user computing device comprising a goods identification section further comprising one or more goods identifiers that identify a good purchased by the electronic ticket and a image display section configured to display image content that can be authenticated by an authenticator.

The image content may be a video content being captured by a front camera of the user computing device or video content being captured by a front camera of the user computing device or a back camera of the user computing device. The image content may be received by the user computing device, for example from a video streaming server.

The image display section may comprise the background of the entire electronic ticket and the goods identification section may comprise the foreground of the electronic ticket. The placement and size of the image display section may be changeable and may be changeable according to an algorithm, such algorithm may be implemented by an authentication server or by a mobile ticketing application operating on the user computing device.

The good purchased by the electronic ticket may be a transit service and the authenticator may be an operator providing such transit service.

The authentication may be confirming that the image display section is displaying video from the immediate surroundings of the user computing device. The authentication may be confirming that the image display section is displaying the video being received from the video streaming server.

The authenticator may be an operator and the operator has an operator computing device displaying the video being received from the video streaming server and wherein authentication involves confirming that the video on the operator computing device matches the video on the user computing device.

There is further a system for secure electronic ticketing for the purchase of a vendor's goods, via an electronic ticket, by a purchaser comprising an electronic ticketing application configured to allow the purchaser to purchase an electronic ticket for a vendor's goods, and an electronic ticket further comprising a goods identification section further comprising one or more goods identifiers that identify a good purchased by the electronic ticket and a image display section configured to display image content that can be authenticated by an authenticator.

The image content may be the image content being captured by a front camera of the user computing device. The image content may be the image content being captured by a front camera of the user computing device or a back camera of the user computing device.

The image content may be received by the user computing device.

The system may further comprise a video streaming server configured to stream image content to be displayed in the image display section of the electronic ticket.

The image display section may comprise the background of the entire electronic ticket and the goods identification section may comprise the foreground of the electronic ticket. The placement and size of the image display section may be changeable. The placement may be changed according to an algorithm. The algorithm may be implemented by an authentication server or by the mobile ticketing application.

The good purchased by the electronic ticket is a transit trip and the authenticator is an operator providing such transit service.

The authentication may be confirming that the image display section is displaying video from the immediate surroundings of the user computing device. The authentication may be confirming that the image display section is displaying the video being received from the video streaming server.

The authenticator may be an operator and the system may further comprise an operator computing device displaying the video being received from the video streaming server and wherein authentication comprises confirming that the video on the operator computing device matches the video on the user computing device.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a system for secure electronic ticketing according to a non-limiting embodiment of the present invention;

FIG. 2 is a diagram of an electronic ticket displayed on a user computing device screen displaying a user computing device application according to a non-limiting embodiment of the present invention;

FIGS. 3A-3C are diagrams of electronic tickets according to non-limiting embodiments of the present invention; and

FIG. 4 is diagram of an operator computing device user display according to a non-limiting embodiment of the present invention.

### DETAILED DESCRIPTION OF THE INVENTION

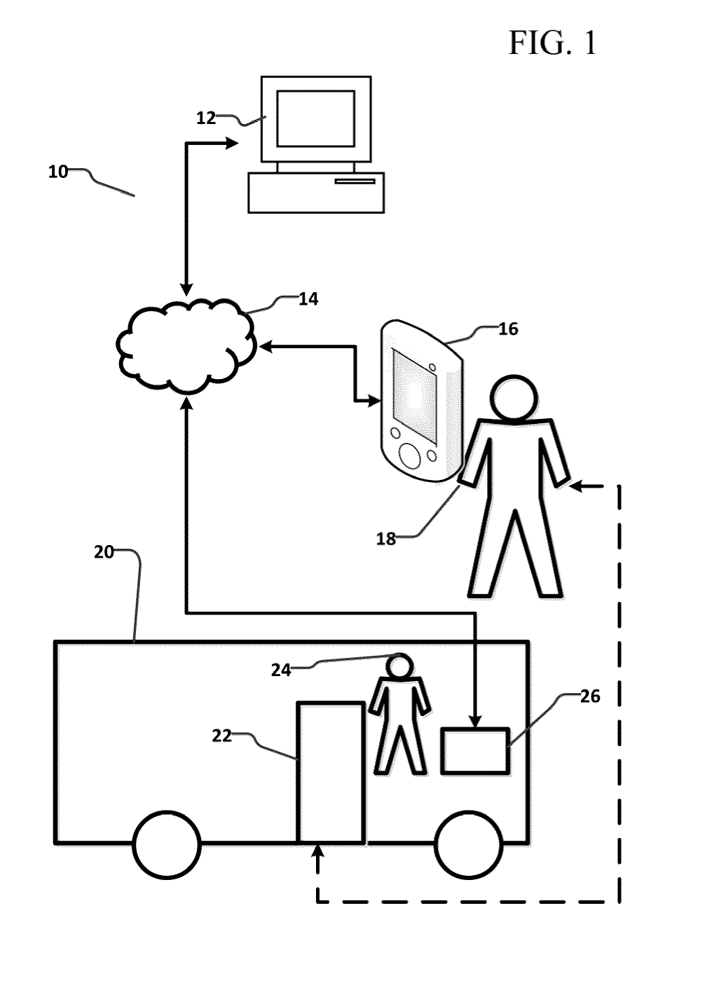

FIG. 1 is a diagram of system 10 for secure electronic ticketing according to a non-limiting embodiment of the present invention comprising server 12, communication network 14, user computing device (UCD) 16, user/rider 18, transit vehicle 20 further comprising door 22, transit vehicle operator 24, and operator computing device (OCD) 26.

System 10 allows for secure electronic ticketing—purchasing of goods or services where an electronic ticket is received in exchange for payment, the electronic ticket later being used to redeem or receive the goods or services. Although approaches to electronic ticketing exist, the systems described herein improve such systems by reducing the opportunity for fraudulent electronic tickets to be redeemed for the goods or services. In a similar fashion to regular/paper tickets, electronic tickets must be checked or authenticated as the purchaser is attempting to redeem the ticket (such as to get on the bus).

As used herein, the term transit product or transit service shall refer to a good or service provided by a transit company. Typically such tickets would be for trips or rides, on transit vehicles 20 such as buses, subways, airplanes, boats, taxis and the like.

Server 12 may be a image content server, transit operation server, authentication server, a combination thereof, or substantially any other server providing the functionality described herein. The above terms will be used interchangeably herein.

Image content server 12 may provide image content, via communication network for example, to UCD 16, to be displayed in image display section 206 in electronic ticket 200. Image content server may also be referred to as a video streaming server.

Transit operation server 12 may provide functionality required by UCDA 210 to facilitate the purchase of transit goods or services. For example, transit operation server may run a software program that maintains and communicates a schedule of transit goods or services that may be purchased by user 18 via UCDA 210 to obtain electronic ticket 200. The ability to create and communicate an electronic ticket 200 to UCD 16 may be as known in the prior art, such as Trapeze's electronic ticketing application.

Authentication server 12 may assist in authenticating electronic ticket 200. Such authentication may be via one or more methods involving image content being displayed in video display 206, as described herein.

Communication network 14 may be substantially any public or private network, wired or wireless, and may be substantially comprised of one or more networks that may be able to facilitate communication between themselves. Communication network 14 may be one or more LANs, WANs and may be implemented using one or more protocols or underlying technologies. Many examples of communication networks are known in the art, and the present communication network 14 is not precluded from any of such provided they facilitate the functionality attributed to communication network 14 as described herein.

UCD 16 may be any computing device that is used by a user/rider/purchaser 18 who wishes to purchase an electronic ticket and use it for a transit product. UCD 16 may have an application thereon, UCDA 210, that facilitates the purchase of a ticket. Alternatively, UCD 16 may enable purchasing electronic ticket 200 via accessing a website using a browser on UCD 16. Where electronic ticket 200 may be obtained or stored independently of UCDA 210, it may have embedded information (such as executable computer instructions) that cause the functionality described herein.

OCD 26 may be a computing device that is used by transit vehicle operator 24 or is otherwise used as part of the functionality of system 10 as described herein. Although contemplated as being used by a transit vehicle operator, OCD 26 may simply be located proximate to a transit vehicle (such as on or in it, or near a location where a rider may board transit vehicle 20). OCD 26 may also be known as an authentication computing device (ACD) where, for example, it may authenticate an electronic ticket with or without interaction by transit vehicle operation 24.

It will further be appreciated that the systems, and elements thereof, described herein (such as server 12, UCD 16 and OCD 26) may be implemented using one or more computer apparatuses such as personal computers, laptops, smart phones, and the like. Each of those computer apparatuses may have one or more computer readable media (such as RAM, ROM, hard drives or the like, as would be known in the art but are not shown herein) that may store a plurality of programming instructions, said programming instructions executable by the computing apparatus (such as applications, including electronic ticketing application 210), such as by one or more processors, and able to communicate with the computer readable media including databases and tables as described herein.

Transit vehicle operator 24 may be located inside transit vehicle 20 (such as a bus driver, that rider 18 sees upon entering through door 22), or may be located external to the transit vehicle 20 (such as a subway platform monitor). Although contemplated as being somewhat local to the transit vehicle 20, transit vehicle operator 24 may also be remote therefrom, for example where automated machines allow access to transit vehicles 20.

In an exemplary electronic ticketing transaction, a rider 18 may purchase an electronic ticket 200, using their UCD 16 and UCDA 210, to purchase a ride on a bus. Some time later, the user arrives at the bus stop. When the bus arrives, user 18 boards and shows their electronic ticket 200 to the transit vehicle operator 24. At that point, authentication of electronic ticket 200 may occur.

### Authentication

There may be substantially two diverging approaches to authentication of electronic ticket 200: Operator-Independent and Server-Based. Such approaches will be described below and herein.

Operator-Independent/Manual

In Server-Independent/Manual authentication, electronic ticket 200 may be authenticated by an operator of transit vehicle 20, another person that may be physically present when user 18 is about to, or is currently, using the transit product represented by electronic ticket 200 (either being an “authenticator”) or via rider 18 presenting electronic ticket 200 to a authentication device (which may be OCD 26). Such authentication may be accomplished without the authenticator relying on anything beyond themselves and/or their OCD 26 (for example not requiring OCD 26 to communicate with server 12 etc).

Various embodiments of Operator-Independent authentication are considered, including:
(a) authenticator looking at electronic ticket 200 and inspecting display section 206 to confirm that the image content in image display section 206 of UCD 16 is what was (or is being) captured by a front camera (not shown) of UCD 16, a back camera (not shown) of UCD 16, or a combination thereof, as described herein;
(b) authenticator looking at electronic ticket 200 and inspecting display section 206 to confirm that the image content in image display section 206 of UCD 16 (and/or characteristics thereof, such as location/size/colors of image display section 206 and whether it is still or video content) matches image content 404 on OCDA 400 and the characteristics it should have (as described in security parameters display 406 or as simply shown in UCD screen match 402);
(c) ACD 26, with or without interaction with transit vehicle operation 24, interacts with UCD 16 so that ACD 26 can authenticate electronic ticket 200. For example, ACD may take a picture of electronic ticket 200 and, among other comparisons that may be desired, compare the image content in image display section to its image content, or image content that ought to be present.

Server-Based/Automated

In Server-Based/Automated authentication, electronic ticket 200 may be authenticated by, or in conjunction with, a comparison to another image content source. Such comparison may be effected using UCD 16 (UCDA 210), server 12, OCD 26, or a combination thereof.

Various embodiments of Server-Based authentication are considered, including:
(a) server 12 may send image content to UCDA 210 for display in image display section 206, while it sends the same, or relatable, image content to OCD 26. When UCD 16 is presented to an operator having OCD 26, the operator can confirm that the same, or related, image content is being displayed. Being “related” or “matching” in such a context may involve them being the same image (or video), a time lag, opposites being displayed (such as a green traffic light on one and a red traffic light on the other), or other approaches where an operator would know that the image display section 201 is showing the right image content.
(b) In a second embodiment, OCD 26 may be running an OCD application (OCDA) (not shown) that can be interacted with by transit vehicle operator 24 to enter characteristics of the image display section 206 of UCD 16. Such characteristics may be sent by OCD 26 to server 12, and server 12 may send a response indicating electronic ticket 200 has been authenticated. Characteristics may include whether the image content is still or moving, what it depicts, how large it is on UCDA 210 screen and where it is on UCDA 210 screen;

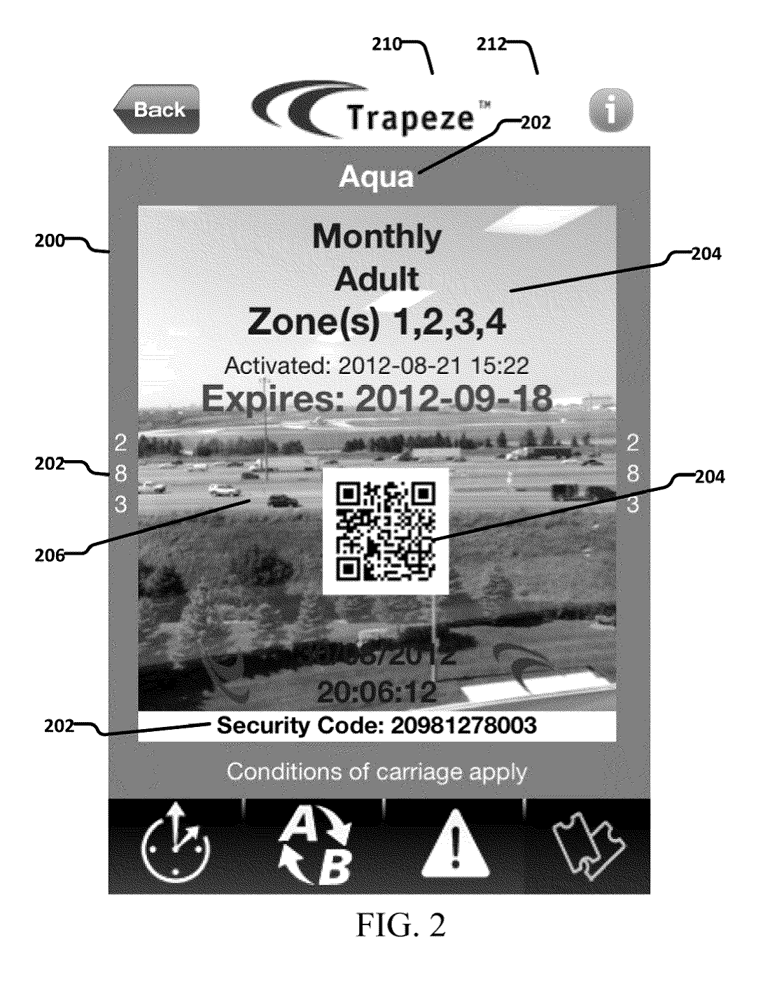

FIG. 2 is a diagram of an electronic ticket 200 displayed on a user computing device screen (UCDS) 210 displaying a user computing device application (UCDA 212) according to a non-limiting embodiment of the present invention, the electronic ticket 200 comprising security features 202, goods identification section 204, and image display section 206.

UCDS 210 may be substantially any type of screen or user display on UCD 16. UCDA 212 may be substantially any type of application being executed on UCD 16, such as an application or a content being accessed by an application (such as a website being accessed by a browser). As shown in FIG. 2, UCDA 212 may occupy some portion of UCDS 210 when UCDA 212 is in the foreground, though it need not comprise the entire screen, as is known in the art. UCDA 212, OCDA 400 and software executing on server 12 may, alone or in combination with one another, also be referred to as one or more mobile ticketing applications.

Security features 202 may be one or more other techniques, that may be known in the art, to reduce the chances of fraudulent electronic tickets 200.

Image display section 206 may be a portion of the display of UCDA 212 being presented on UCDS 210, and may be part of, or at least shown at the same time as, electronic ticket 200. Image display section 206 may display videos or images, as described herein, that may originate from one or more cameras on UCD 16, or from another image content source (such as server 12) and stored on, or streamed to UCD 16.

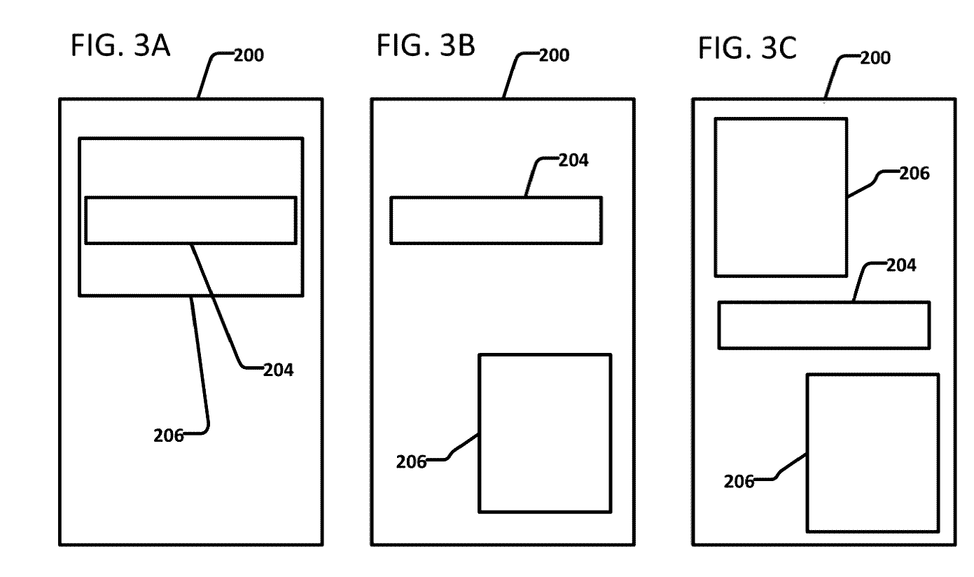

As shown in FIGS. 3A-3C, image display section 206 may be one or more separate or attached areas (as in FIG. 3C) and may be located in one more areas of electronic ticket 200 (top in 3A, bottom right in 3B and in top left and bottom right in 3C). Image display section 206 may be of different sizes as well.

Changes to image display section 206 may be controlled by an algorithm to help reduce fraud and ensure that there are enough characteristics that can be authenticated (independently or together, simultaneously or separately). Such an algorithm may be stored on, and/or executed on, UCD 16, server 12 or OCD 26.

In operation, when rider 18 wishes to redeem electronic ticket 200, they will either activate it, or make it visible (so as to prepare it for authentication). At one of such times, or as otherwise appropriate, the appropriate image content and image display section 206 will be set in electronic ticket 200. For example, either video or still image content will be selected, an image content source will be selected (front or back camera, stored video or image, video or image from server 12, etc). Image display section 206 will also be established (location, size, etc) as described herein.

In one embodiment, such an algorithm may be run on server 12 and server 12 may communicate to UCD 16 and OCD 26 that image display section 206 should be in the bottom right corner. The authenticator then knows to expect it to be in the bottom right and even if the content in the Image display section 206 is proper (say a picture taken by the front camera of UCD 16, perhaps even showing the authenticator), the electronic ticket 200 is fraudulent.

Good identification section 204 may identify the transit product that was purchased in obtaining the electronic ticket 200. Good identification section 204 may comprise many details, such as dates, route or bus identifiers, seat numbers, number of zones, and other details. Good identification section 204 may be text form or may be other forms, such as computer readable forms like bar codes, QR codes, and the like. Good identification section 204 may be in one or more parts and may be overlayed overtop of image display section 206, for example.

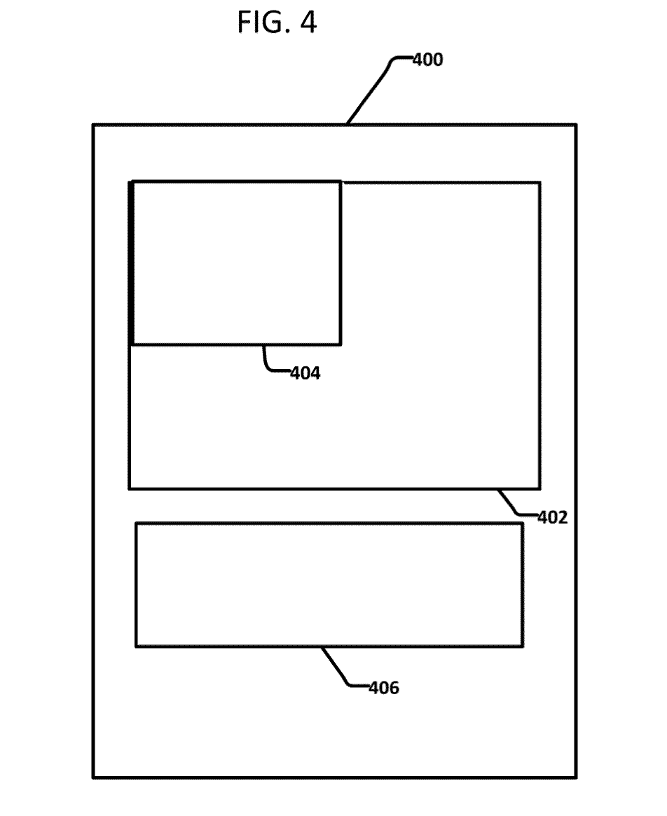

FIG. 4 is diagram of an operator computing device 26 user display displaying operator computing device application 400 according to a non-limiting embodiment of the present invention, comprising image display section 404, parameters display 406 and UCD screen match 402.

UCD screen match 402 may show the location and size that image display section 206 should be on UCD 16 for an electronic ticket 200 to be valid and authenticated.

Image display section 404 may show the image (video or still, etc) that should be on UCD 16, or should serve as a comparison, for an electronic ticket 200 to be valid and authenticated.

Parameters display 406 may provide further information to authenticate electronic ticket 200, such as security features 202, or other aspects of the image content.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A secure electronic ticket, for the purchase of goods by a purchaser, displayable on a user display of a user computing device comprising:
a goods identification section further comprising one or more goods identifiers that identify a good purchased by the electronic ticket; and
a image display section configured to display image content that can be authenticated by an authenticator.

2. The electronic ticket of claim 1 wherein the image content is a video content being captured by a front camera of the user computing device.

3. The electronic ticket of claim 1 wherein the image content is a video content being captured by a front camera of the user computing device or a back camera of the user computing device.

4. The electronic ticket of claim 1 wherein the image content is received by the user computing device.

5. The electronic ticket of claim 4 wherein the image content is received from a video streaming server.

6. The electronic ticket of claim 1 wherein the image display section comprises the background of the entire electronic ticket and the goods identification section comprises the foreground of the electronic ticket.

7. The electronic ticket of claim 1 wherein the placement and size of the image display section is changeable.

8. The electronic ticket of claim 7 wherein the placement is changed according to an algorithm.

9. The electronic ticket of claim 8 wherein the algorithm is implemented by an authentication server.

10. The electronic ticket of claim 8 wherein the algorithm is implemented by a mobile ticketing application operating on the user computing device.

11. The electronic ticket of claim 1 wherein the good purchased by the electronic ticket is a transit service and the authenticator is an operator providing such transit service.

12. The electronic ticket of claim 11 wherein the authentication is confirming that the image display section is displaying video from the immediate surroundings of the user computing device.

13. The electronic ticket of claim 5 wherein the authentication is confirming that the image display section is displaying the video being received from the video streaming server.

14. The electronic ticket of claim 13 wherein the authenticator is an operator and the operator has an operator computing device displaying the video being received from the video streaming server and wherein authentication involves confirming that the video on the operator computing device matches the video on the user computing device.

15. A system for secure electronic ticketing for the purchase of a vendor's goods, via an electronic ticket, by a purchaser comprising:
an electronic ticketing application configured to allow the purchaser to purchase an electronic ticket for a vendor's goods, and an electronic ticket further comprising a goods identification section further comprising one or more goods identifiers that identify a good purchased by the electronic ticket and a image display section configured to display image content that can be authenticated by an authenticator.

16. The system of claim 15 wherein the image content is the image content being captured by a front camera of the user computing device.

17. The system of claim 15 wherein the image content is the image content being captured by a front camera of the user computing device or a back camera of the user computing device.

18. The system of claim 15 wherein the image content is received by the user computing device.

19. The system of claim 18 further comprising a video streaming server configured to stream image content to be displayed in the image display section of the electronic ticket.

20. The system of claim 15 wherein the image display section comprises the background of the entire electronic ticket and the goods identification section comprises the foreground of the electronic ticket.

21. The system of claim 15 wherein the placement and size of the image display section is changeable.

22. The system of claim 21 wherein the placement is changed according to an algorithm.

23. The system of claim 22 wherein the algorithm is implemented by an authentication server.

24. The system of claim 22 wherein the algorithm is implemented by the mobile ticketing application.

25. The system of claim 15 wherein the good purchased by the electronic ticket is a transit trip and the authenticator is an operator providing such transit service.

26. The system of claim 25 wherein the authentication is confirming that the image display section is displaying video from the immediate surroundings of the user computing device.

27. The system of claim 19 wherein the authentication is confirming that the image display section is displaying the video being received from the video streaming server.

28. The system of claim 27 wherein the authenticator is an operator and the system further comprises an operator computing device displaying the video being received from the video streaming server and wherein authentication comprises confirming that the video on the operator computing devices matches the video on the user computing device.
